(19) United States
(12) Patent Application Publication
(10) Pub. No.: US 2023/0268537 A1
(43) Pub. Date: Aug. 24, 2023

(54) Ultrasonic methanol fuel cell system converting liquid fuel to gas fuel

(71) Applicant: Zhijun PENG, Foshan (CN)

(72) Inventor: Zhijun PENG, Foshan (CN)

(21) Appl. No.: 18/093,336

(22) Filed: Jan. 5, 2023

(30) Foreign Application Priority Data
Feb. 20, 2022 (CN) 202210153919.9

(51) Int. Cl. H01M 8/0612; H01M 8/1018

(52) U.S. Cl. CPC H01M 8/0612; H01M 8/1018; H01M 2008/1095

(57) ABSTRACT

An ultrasonic methanol fuel cell system converting liquid fuel to gas fuel, including a methanol fuel cell body, an ultrasonic fuel atomization mechanism, a mist-transporting booster pump; the ultrasonic fuel atomization mechanism includes a fuel storage chamber, an ultrasonic atomizer module, a mist output pipe and an internal pressure equalizer; the ultrasonic atomizer module is provided at the bottom of the fuel storage chamber; the mist output pipe is provided above the ultrasonic atomizer module; the internal pressure equalizer is connected with the mist output pipe; a pressure equalizing valve is connected to the outer end of the internal pressure equalizer; the mist-transporting booster pump is connected between the fuel input port and the mist output pipe. Fuel is atomized via the ultrasonic fuel atomization mechanism, and is then transported by the mist-transporting booster pump to the methanol fuel cell body for chemical reactions to be converted into electrical energy.

### FIELD OF THE INVENTION

This invention relates to the technical field of fuel cell and specifically relates to a methanol fuel cell system.

### BACKGROUND OF THE INVENTION

A methanol fuel cell (Direct methanol fuel cell, DMFC) is a low-temperature fuel cell that uses a proton exchange membrane as the solid electrolyte and methanol as the fuel. A single cell of a methanol fuel cell is mainly composed of a membrane electrode, bipolar plates, current collector plates and sealing gaskets. The membrane electrode comprising a catalyst layer and a proton exchange membrane is the core component of the fuel cell, and all the electrochemical reactions of the fuel cell take place at the membrane electrode. The main function of the proton exchange membrane is to conduct protons while blocking electrons, and at the same time acts as a membrane to prevent the crossing of the fuels between the two poles. The main function of the catalyst is to reduce the activation overpotential of the reaction and facilitate reactions at the electrode.

As the technology of methanol fuel cell advances, the outlook for its industrialization and practical application has become more optimistic. To improve the performance of the steady-state discharge of methanol fuel cells, Wuhan University of Technology proposed to set up ultrasonic transducers on a fuel supply channel (i.e., polar plate flow field) of the methanol fuel cell, so that ultrasonic vibration generated by the ultrasonic transducers is transmitted to the fuel in the channel by radiation. Thereby, the fuel is atomized, which is more easily absorbed by the catalyst layer to undergo chemical reaction, improving the performance of the steady-state discharge of the methanol fuel cell. For details, please refer to the patent document published by the China National Intellectual Property Administration (Publication number: CN103633352A). Although the invention by Wuhan University of Technology has provided certain theoretical basis and directions for the research on the development of methanol fuel cells, the invention is only theoretically feasible and is difficult to be applied on practical industrial settings. This is due to the limited space in the narrow channel of the methanol fuel cell. Therefore, the Applicant believes that the problem of feasibility still exist in the aforementioned method for improving the performance of the steady-state discharge of methanol fuel cells.

### BRIEF SUMMARY OF THE INVENTION

To solve the above technical problem, the present invention provides an ultrasonic methanol fuel cell system converting liquid fuel to gas fuel, which atomizes the liquid fuel into a mist state via an ultrasonic fuel atomization mechanism. The atomized fuel is transported from the mist-transporting booster pump to the methanol fuel cell body to be converted into electric energy via chemical reactions. This does not only enhances the performance of the steady-state discharge of the methanol fuel cell, but also possesses concrete economic value due to its simple structure and easy implementation of the technical solution.

The technical solution of this invention is as follows: an ultrasonic methanol fuel cell system converting liquid fuel to gas fuel, comprising a methanol fuel cell body, which comprises a fuel input port, a fuel output port, an oxidant input port, and an oxidant output port, wherein the ultrasonic methanol fuel cell system also comprises an ultrasonic fuel atomization mechanism and a mist-transporting booster pump, wherein the ultrasonic fuel atomization mechanism comprises a fuel storage chamber, an ultrasonic atomizer module, a mist output pipe and an internal pressure equalizer; the ultrasonic atomizer module is provided at a bottom of the fuel storage chamber, and the mist output pipe is provided above the ultrasonic atomizer module; the internal pressure equalizer is connected with the mist output pipe, and a pressure equalizing valve is connected to an outer end of the internal pressure equalizer; the mist-transporting booster pump is connected between the fuel input port and the mist output pipe, so as to pump the atomized fuel to the methanol fuel cell body.

Furthermore, the ultrasonic fuel atomization mechanism also comprises a bottom shell, wherein the ultrasonic atomizer module is installed; the fuel storage chamber is provided on the bottom shell; the mist output pipe 23 is provided across the fuel storage chamber, and is connected with the ultrasonic atomizer module.

Furthermore, the fuel storage chamber is provided with a fuel addition port.

Benefits of this invention are as follows: This methanol fuel cell system utilizes the ultrasonic fuel atomization mechanism to atomize the fuel into mist, which is then sent to the methanol fuel cell body by a mist-transporting booster pump to be converted into electrical energy via chemical reactions. This does not only improve the performance of the steady-state discharge of the methanol fuel cell, but also possess economic benefits due to its simple structure and easy implementation of the technical solution. In addition, the use of atomized fuel for reaction power generation also improves the utilization rate of fuel energy, which saves energy and improves the energy efficiency ratio of power generation per liter of fuel.

### BRIEF DESCRIPTION OF THE DRAWINGS

FIG. 1 is a schematic view of this invention.

FIG. 2 is a schematic view of the proton exchange membrane of this invention.

FIG. 3 is a top view of the ultrasonic fuel atomization mechanism of this invention.

### DETAILED DESCRIPTION OF THE INVENTION

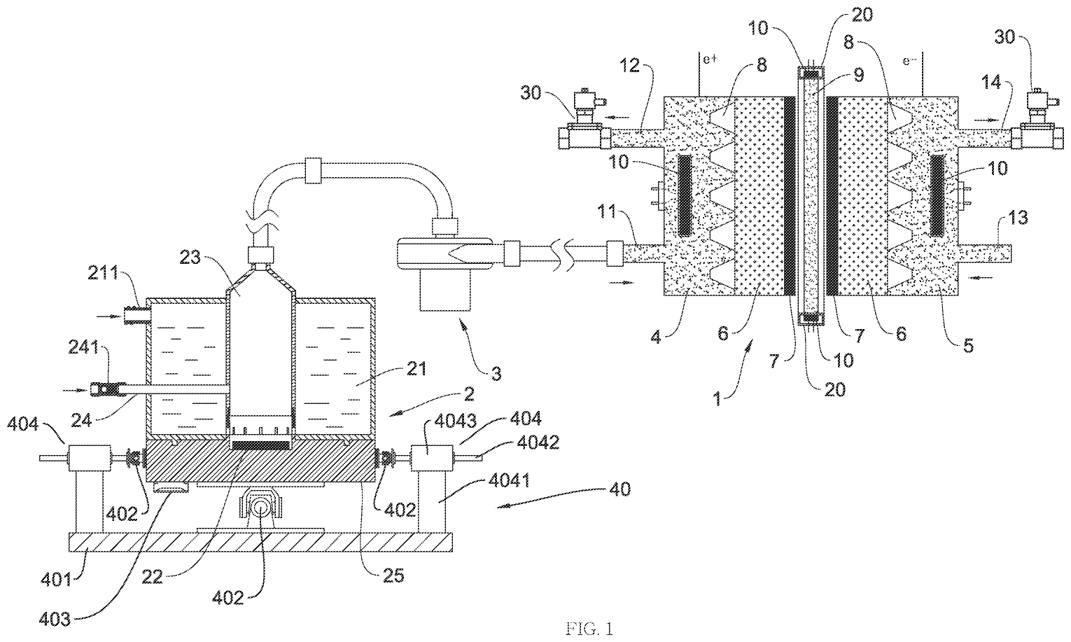

As shown in FIG. 1, an ultrasonic methanol fuel cell system converting liquid fuel to gas fuel, comprising a methanol fuel cell body 1, which comprises a fuel input port 11, a fuel output port 12, an oxidant input port 13 and an oxidant output port 14. This invention also comprises an ultrasonic fuel atomization mechanism 2 and a mist-transporting booster pump 3, wherein the ultrasonic fuel atomization mechanism 2 comprises a fuel storage chamber 21, an ultrasonic atomizer module 22, a mist output pipe 23 and an internal pressure equalizer 24; the ultrasonic atomizer module 22 is provided at the bottom of the fuel storage chamber 21, and the mist output pipe 23 is provided above the ultrasonic atomizer module 22. The internal pressure equalizer 24 is connected with the mist output pipe 23, and a pressure equalizing valve 241 is connected to an outer end of the internal pressure equalizer 24; the mist-transporting booster pump 3 is connected between the fuel input port 11 and the mist output pipe 23, so as to pump the atomized fuel to the methanol fuel cell body 1. The pressure equalizing valve 241 is used to input a small amount of gas (such as inert gas), which does not participate in the chemical reactions, into the mist output pipe 23 to avoid internal vacuum in the mist output pipe when the mist-transporting booster pump 3 extracts atomized fuel. In addition, the atomization efficiency and power of the ultrasonic atomizer module 22 should be 1.5 times of the fuel consumption rate of the methanol fuel cell body 1, to ensure that the supply of atomized fuel of the methanol fuel cell remains sufficient during operation.

The ultrasonic fuel atomization mechanism 2 is designed to form a relatively integrated structure to be easily installed on a corresponding equipment in practical application. As shown in FIG. 1, the ultrasonic fuel atomization mechanism 2 also includes a bottom shell 25, wherein the ultrasonic atomizer module 22 is installed; the fuel storage chamber 21 is provided on the bottom shell 25; the mist output pipe 23 is provided across the fuel storage chamber 21, and is connected with the ultrasonic atomizer module 22. Meanwhile, for a continuous replenishment of fuel into the fuel storage chamber 21, a fuel addition port 211 is further provided on the fuel storage chamber 21. The fuel addition port 211 may be installed with a sealing cover or connected to a pipeline, such that a fuel tank supplies fuel to the fuel storage chamber 21 through the pipeline.

As shown in FIG. 1, the methanol fuel cell body 1 comprises a positive plate 4, a negative plate 5, diffusion layers 6, catalytic layers 7, polar plate flow fields 8 and a proton exchange membrane 9, wherein the polar plate flow fields 8 are provided on both an inner side of the positive plate 4 and an inner side of the negative plate 5; the diffusion layers 6 cover the polar plate flow fields 8, and the catalytic layers 7 cover on the diffusion layers 6; the proton exchange membrane 9 is provided between the catalytic layers 7 on the inner sides of the positive plate 4 and of the negative plate 5; the fuel input port 11 and the fuel output port 12 are provided on an outer side of the positive plate 4; the oxidant input port 13 and the oxidant output port 14 are provided on an outer side of the negative plate 5. To enhance the performance of the steady-state discharge and the discharge efficiency of the methanol fuel cell, as shown in FIG. 1, an ultrasonic component 10 may be embedded in the positive plate 4 or the negative plate 5, or alternatively embedded in each of both the positive plate 4 and the negative plate 5. Through the high-frequency radiation of sound waves from the ultrasonic component 10, the atomized fuel and the oxidant input into the cell undergo chemical reactions more efficiently, such that the cell can output a more stable voltage to the e+ electrode (positive electrode) and the e-electrode (negative electrode). In addition, the ultrasonic high-frequency vibration generated accelerates the movement of the internal molecules in the cell fluid to increase the temperature of the cell and enhances the charge and discharge efficiency. This invention also solves the problem of low power generation efficiency and inability to operate in an extremely cold environment, such as winter.

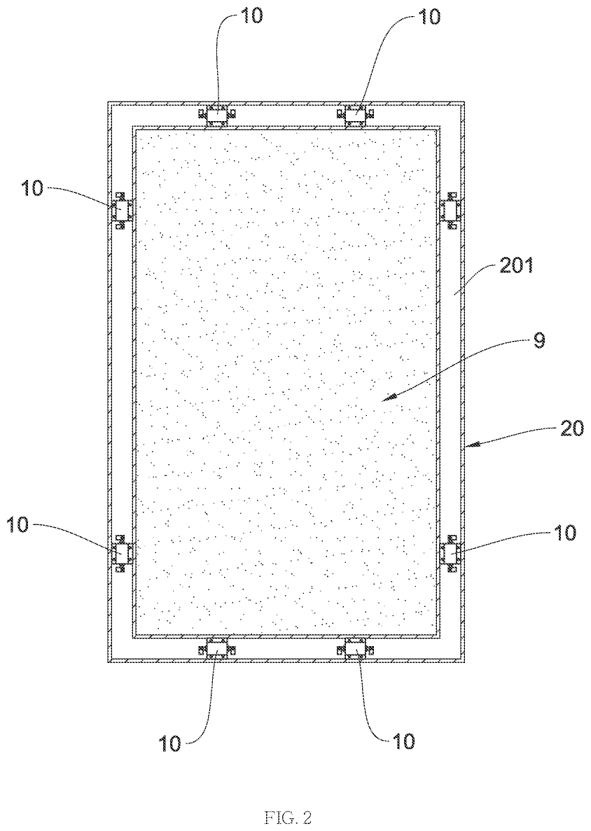

As shown in FIG. 1 and FIG. 2, the proton exchange membrane 9 is further provided with a side frame 20, wherein ultrasonic components 10 are also embedded. Specifically, as shown in FIG. 2, an inner cavity 201 is provided along a periphery of the side frame 20, and the ultrasonic components 10 are distributed in the inner cavity 201, such that the proton exchange membrane 9 is evenly subject to ultrasonic vibration. When the ultrasonic components 10 are operating, the high-frequency ultrasonic vibration directly acts on the proton exchange membrane 9 and forms an ultrasonic cavitation effect, which accelerates the movement of the internal molecules. This prevents the cell from formation of useless impurities on the proton exchange membrane 9 during chemical reactions which may otherwise block the capillary pores of the proton exchange membrane 9 and may affect its normal operation and service life. The high-frequency ultrasonic vibration of the ultrasonic components 10 shakes off impurities adhering to the proton exchange membrane 9, ensuring a normal performance of the proton exchange membrane 9 and prolonging its service life. The high-frequency vibration generated also accelerates the movement of internal molecules in the cell liquid, so as to increase the temperature of the cell and enhances charge and discharge efficiency. This invention also solves the problem of low power generation efficiency and inability to operate in an extremely cold environment, such as winter.

An outer surface of each of the ultrasonic components 10 is covered with an insulating and sealing protective case. The ultrasonic components 10 are ultrasonic transducers of 1 MHz or above, or ultrasonic vibration motors of 10,000 revolutions per minute or above, to obtain better ultrasonic cavitation effect and performance. In addition, the ultrasonic components 10 may be flat-shaped or strip-shaped depending on their positions in the cell.

In addition, in order to ensure thorough chemical reaction of the atomized fuel after entering the cell and sufficient stay of the atomized fuel before leaving the cell, as shown in FIG. 1, the fuel output port 12 is connected with an electronic relief valve 30. By controlling the electronic relief valve 30, the atomized fuel stays in the cell for a time long enough to infiltrate the catalytic layers 7 and undergoes chemical reaction, thereby improving the utilization rate of the fuel. Similarly, another electronic relief valve 30 is connected to the oxidant output port 14 to control the time of the oxidant staying in the cell via the electronic pressure relief valve 30 on the oxidant output port, thereby achieving full utilization of the oxidant.

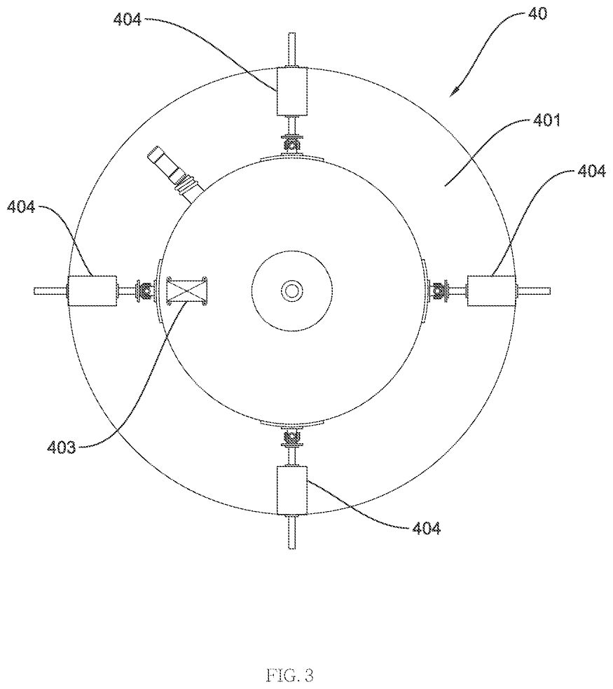

As shown in FIG. 1 and FIG. 3, this invention also comprises a dynamic self-balancing mechanism 40, a middle position of which is tiltably connected to the bottom of the ultrasonic fuel atomization mechanism 2, and four lateral sides of the dynamic self-balancing mechanism 40 are tiltably connected with lateral sides of the ultrasonic fuel atomization mechanism 2 respectively, such that the ultrasonic fuel atomization mechanism 2 is kept in a balanced state through the dynamic self-balancing mechanism 40. The dynamic self-balancing mechanism 40 always maintains the ultrasonic fuel atomization mechanism 2 in a vertical state, hence maintains a full contact between the fuel input to the ultrasonic fuel atomization mechanism 2 and the ultrasonic atomizer module 22. Therefore, the efficiency of atomization will not be affected, and the ultrasonic atomizer module will not be burnt due to lack of liquid.

To achieve simple structure, low production cost, high reliability and easy realization of the dynamic self-balancing mechanism 40, as shown in FIG. 1, the dynamic self-balancing mechanism 40 comprises a base mounting seat 401, universal joints 402, an electric gyroscope 403 and a plurality of modifying and regulating motors 404; the base mounting seat 401 is connected with the bottom of the ultrasonic fuel atomization mechanism 2 through one of the universal joints 402; the modifying and regulating motors 404 are connected with lateral sides of an upper surface of the base mounting seat 401, and the modifying and regulating motors 404 are respectively connected with the lateral sides of the ultrasonic fuel atomization mechanism 2 through the other corresponding universal joints 402; the electric gyroscope 403 is installed on a bottom surface of the ultrasonic fuel atomization mechanism 2. During operation, the electric gyroscope 403 detects a tilting direction of the ultrasonic fuel atomization mechanism 2 and sends a corresponding signal of the detected tilting direction to a main control circuit board; according to such signal, the main control circuit board sends a command to the modifying and regulating motors 404 corresponding to the tilted direction to adjust the ultrasonic fuel atomization mechanism 2 to a non-tilted balanced state.

To achieve simple structure, easy production and low production cost of the regulating motors 404, as shown in FIG. 1, each of the modifying and regulating motors 404 comprises a vertical support 4041, a horizontal push rod 4042, and a motor 4043. A bottom end of the vertical support 4041 is connected to the base mounting seat 401; the motor 4043 is installed on a top end of the vertical support 4041; one end of the horizontal push rod 4042 is connected to the motor 4043, and another end of the horizontal push rod 4042 is connected to a corresponding universal joint 402.

In actual implementation, this invention generally comprises a controller or a MCU to control the operation of the ultrasonic components 10, the dynamic self-balancing mechanism 40 and the mist-transporting booster pump 3. The controller or the MCU comprises a circuit control board; beside, a MCU programmable main control chip as well as a Wi-Fi communication module or a Bluetooth® communication module may be configured onto the circuit control board. Together with a corresponding application program written and installed on smart phones and tablet computers, etc., wireless communication and control will be achieved. This invention may also be operated by wire control or remote control.

What is claimed is:

1. An ultrasonic methanol fuel cell system converting liquid fuel to gas fuel, comprising a methanol fuel cell body (1), which comprises a fuel input port (11), a fuel output port (12), an oxidant input port (13), and an oxidant output port (14); the ultrasonic methanol fuel cell system is characterized by also comprising an ultrasonic fuel atomization mechanism (2) and a mist-transporting booster pump (3), wherein:
the ultrasonic fuel atomization mechanism (2) comprises a fuel storage chamber (21), an ultrasonic atomizer module (22), a mist output pipe (23) and an internal pressure equalizer (24); the ultrasonic atomizer module (22) is provided at a bottom of the fuel storage chamber (21), and the mist output pipe (23) is provided above the ultrasonic atomizer module (22); the internal pressure equalizer (24) is connected with the mist output pipe (23), and a pressure equalizing valve (241) is connected to an outer end of the internal pressure equalizer (24);
the mist-transporting booster pump (3) is connected between the fuel input port (11) and the mist output pipe (23), so as to pump atomized fuel to the methanol fuel cell body (1).

2. The ultrasonic methanol fuel cell system converting liquid fuel to gas fuel of claim 1, wherein the ultrasonic fuel atomization mechanism (2) also comprises a bottom shell (25), wherein the ultrasonic atomizer module (22) is installed; the fuel storage chamber (21) is provided on the bottom shell (25); the mist output pipe (23) is provided across the fuel storage chamber (21), and is connected with the ultrasonic atomizer module (22).

3. The ultrasonic methanol fuel cell system converting liquid fuel to gas fuel of claim 2, wherein a fuel addition port (211) is further provided on the fuel storage chamber (21).

4. The ultrasonic methanol fuel cell system converting liquid fuel to gas fuel of claim 1, wherein the methanol fuel cell body (1) comprises a positive plate (4), a negative plate (5), diffusion layers (6), catalytic layers (7), polar plate flow fields (8) and a proton exchange membrane (9), wherein,
the polar plate flow fields (8) are provided on both an inner side of the positive plate (4) and an inner side of the negative plate (5); the diffusion layers (6) cover the polar plate flow fields (8) on the positive plate (4) and the negative plate (5), and the catalytic layers (7) cover on the diffusion layers (6); the proton exchange membrane (9) is provided between the catalytic layers (7) on the inner sides of the positive plate (4) and of the negative plate (5);
the fuel input port (11) and the fuel output port (12) are provided on an outer side of the positive plate (4); the oxidant input port (13) and the oxidant output port (14) are provided on an outer side of the negative plate (5).

5. The ultrasonic methanol fuel cell system converting liquid fuel to gas fuel of claim 4, wherein an ultrasonic component (10) is embedded in the positive plate (4).

6. The ultrasonic methanol fuel cell system converting liquid fuel to gas fuel of claim 4, wherein an ultrasonic component (10) is embedded in the negative plate (5).

7. The ultrasonic methanol fuel cell system converting liquid fuel to gas fuel of claim 4, wherein the proton exchange membrane (9) is further provided with a side frame (20), wherein ultrasonic components (10) are embedded.

8. The ultrasonic methanol fuel cell system converting liquid fuel to gas fuel of claim 1, further comprising a dynamic self-balancing mechanism (40), a middle position of which is tiltably connected to a bottom of the ultrasonic fuel atomization mechanism (2), and four lateral sides of the dynamic self-balancing mechanism (40) are tiltably connected with lateral sides of the ultrasonic fuel atomization mechanism (2) respectively, such that the ultrasonic fuel atomization mechanism (2) is kept in a balanced state through the dynamic self-balancing mechanism (40).

9. The ultrasonic methanol fuel cell system converting liquid fuel to gas fuel of claim 8, wherein the dynamic self-balancing mechanism (40) comprises a base mounting seat (401), universal joints (402), an electric gyroscope (403), and a plurality of modifying and regulating motors (404); the base mounting seat (401) is connected with the bottom of the ultrasonic fuel atomization mechanism (2) through one of the universal joints (402); the modifying and regulating motors (404) are connected with lateral sides of an upper surface of the base mounting seat (401), and the modifying and regulating motors (404) are respectively connected with the lateral sides of the ultrasonic fuel atomization mechanism (2) through other corresponding universal joints (402); the electric gyroscope (403) is installed on a bottom surface of the ultrasonic fuel atomization mechanism (2).

10. The ultrasonic methanol fuel cell system converting liquid fuel to gas fuel of claim 9, wherein each of the modifying and regulating motors (404) comprises a vertical support (4041), a horizontal push rod (4042), and a motor (4043); a bottom end of the vertical support (4041) is connected to the base mounting seat (401); the motor (4043) is installed on a top end of the vertical support (4041); one end of the horizontal push rod (4042) is connected to the motor (4043), and another end of the horizontal push rod (4042) is connected to a corresponding universal joint (402).
